(19) United States
(12) Patent Application Publication
(10) Pub. No.: US 2026/0246541 A1
(43) Pub. Date: Aug. 20, 2026

(54) NETWORK NODE AND METHOD FOR IN-FIELD ANTENNA CALIBRATION

(71) Applicant: Telefonaktiebolaget LM Ericsson (publ), Stockholm (SE)

(72) Inventors: Ang FENG, Solna (SE); Hao ZHANG, Guangzhou (CN); Christian BRAUN, Vallentuna (SE); Jing YU, Taeby (SE); Xiaohui HU, Beijing (CN)

(21) Appl. No.: 19/153,748

(22) PCT Filed: Feb. 14, 2023
(86) PCT No.: PCT/CN2023/075951

§ 371 Date: Aug. 5, 2025

(51) Int. Cl. H04B 17/12

(52) U.S. Cl. CPC H04B 17/12

(57) ABSTRACT

A network node and method therein for antenna calibration in a wireless communication system are provided. The network node comprises includes an antenna array and a number of transceiver chipsets. The antenna array includes a number of antenna subarrays which are arranged in a number of subarray groups (SAGs). The number of SAGs are coupled to the number of transceiver chipsets respectively. The method has a two-step calibration. During a first step calibration, phase and/or amplitude differences for the antenna subarrays in each SAG are compensated during a system power-up. During a second step calibration, phase and/or amplitude differences between the number of SAGs are compensated.

### TECHNICAL FIELD

Embodiments herein relate to antenna calibration. In particular, they relate to a network node and method therein for in-field antenna calibration of an antenna array comprising a number of antenna subarrays in a wireless communication system.

### BACKGROUND

A radio unit in a wireless communication system usually comprise transceivers (TRX) which comprise receivers (RX) and transmitters (TX). The transmitters typically up-convert baseband signals to Radio Frequency (RF) signals for transmission, and the receivers down-convert received RF signals to baseband signals for processing.

The transmitter and receiver in the radio unit usually use multiple antennas to perform beamforming to enhance coverage and capacity. Multiple antennas can significantly increase the data rates and reliability of a wireless communication system. The performance is improved if both the transmitter and the receiver are equipped with multiple antennas, which results in a Multiple-Input Multiple-Output (MIMO) communication system.

Massive MIMO plays a critical role in the 5^{th} Generation communication network and upcoming next-generation communication networks. It can concentrate signal power on one or several dedicate directions to enhance the coverage and suppress the interference. If multiple antennas are also employed at the user side, either single user with multiple antennas, or multiple users with single or multiple antennas per user, the system capacity can be further improved by spatial multiplexing. By exploiting massive MIMO, radio access network (RAN) can achieve unprecedented spectral efficiency with better energy efficiency.

To enable these functionalities, the massive MIMO radio unit, deployed with a large-scale antenna array and numerous RF chains or branches, requires reliable phase coherency among antennas as well as RF chains. However, it is difficult to be guaranteed by the radio unit hardware because of hardware imperfection such as part-to-part variation, traces on printed circuit boards, nonlinearities in the components, coupling effects, frequency divider ratios, hardware aging, clock drifts, temperature drifts, and drifts in local oscillators (LO) etc. To have the best phase coherency, the LO signal should be generated from a common LO source, then distributed to multiple RF chains. But this solution is basically infeasible due to RF losses and RF coupling. A more popular solution is by distributing a common reference clock to multiple RF chains and generating the LO signal locally in each RF chain. However, this solution introduces random starting phase at each power-up circle because the local RF LO must be re-synchronized with the reference clock during every power-up circle.

To enable beamforming, multiple antennas as well as their connected RF components should be aligned coherently. Accurate beamforming relies on the multiple antennas having a closely synchronized amplitude and phase. However, there are impairments between multiple antennas, e.g., the impairments might be caused by unsynchronized phase-locked loop (PLL) among transceivers, or different delays introduced in such as layout of RF circuit board, filter units, isolators and antennas, etc. Such impairments or errors may cause phase and/or amplitude differences between the antennas or antenna subarrays. In order to compensate such impairments, antenna calibration (AC) is used. AC is a typical method to estimate and compensate the impairment of above-mentioned radio hardware imperfections. To achieve accurate beamforming, the multiple antennas must be continuously calibrated while the radio unit is in use.

There are two AC solutions, one is called radio distribution network (RDN) based AC, and another one is called mutual coupling (MC) based AC. In the RDN AC, a RDN board is inserted between RF chains and antennas with a coupler network to transmit and receive the AC signal. It needs extra hardware, so the cost is increased. More important, a massive MIMO radio with RDN board has larger size and heavier weight than the original one. In the MC AC, the calibration loop of AC is established by mutual coupling between TX and RX antennas. Therefore, a RND board is not needed, leading to a low-cost, small-size and lightweight radio unit. However, MC AC needs a high and stable coupling level between TX and RX antennas to make sure the received signal quality is good enough for estimating of phase errors. In general, the AC methods in prior art are not accurate enough. There is a deviation between the impairment compensated by AC and the actual impairment. For this reason, the deviation between the impairment compensated by AC and the actual impairment needs to be further estimated and compensated. Such deviation is called AC error in this application.3GPP Release 18 recently proposes a non-overlap, adjacent channel full-duplex scheme referred to as sub-band full-duplex (SBFD), which allows Frequency Division Duplex (FDD) operation in a Time Division Duplex (TDD) band. Unlike TDD, SBFD creates one or several uplink (UL) carriers between vacant downlink (DL) carriers to increase the throughput and reduce the latency of UL in a DL heavy scenario. The concept attracts lots of studies right now, and will likely be adopted in 5G-advance or 6G networks. The main challenge of SBFD is on how to support a good isolation between TX branches and RX branches. One of the solutions is placing TX antennas and RX antennas in two separate panels, putting a RF barrier between them or applying a nulling beam towards the counterpart. A typical isolation between TX and RX antennas is around 70 dB.

Therefore, in such circumstance, the high isolation between TX and RX antennas basically eradicates the opportunity of MC AC because the calibration loop cannot be closed under such situation.

Meanwhile, both RDN AC and MC AC need to stop traffic data to insert its own calibration signal. That may cause interrupts in the system throughput.

### SUMMARY

It is therefore an object of embodiments herein to provide an improved method for antenna calibration in a wireless communication system.

According to one aspect of embodiments herein, the object is achieved by a network node and method therein for antenna calibration in a wireless communication system. The network node comprises an antenna array and a number of transceiver chipsets. The antenna array comprises a number of antenna subarrays which are arranged in a number of subarray groups (SAGs). The number of SAGs are coupled to the number of transceiver chipsets respectively. The method comprises a two-step calibration.

During a first step calibration,
the network node is configured to obtain compensation values at a system power-up for the number of antenna subarrays comprised in each SAG. The compensation values represent relative phase and amplitude differences between the antenna subarrays in the same SAG for two or more subcarriers. The compensation values may comprise down-link (DL) and/or up-link (UL) compensation values for the two or more subcarriers; and
the network node is further configured to compensate phase and amplitude of the antenna subarrays in each SAG based on the compensation values during the system power-up. The compensation may be performed by multiplying DL data with the DL compensation values and/or multiplying UL data with UL compensation values for the number of antenna subarrays comprised in each SAG.

During a second step calibration,
the network node is configured to estimate a channel-state information (CSI) for the number of antenna subarrays in a SAG at a subcarrier based on a received signal from a user equipment (UE). The channel-state information is represented by a combined channel data matrix comprising channel data contributed from a communication channel between the network node and user equipment and channel data contributed from antenna calibration error between the number of antenna subarrays comprised in the antenna array;
the network node is further configured to calculate a relative antenna calibration error between the number of SAGs for each SAG based on the estimated channel data matrix; and
the network node is further configured to compensate phase and/or amplitude of the antenna subarrays based on the relative antenna calibration error between the number of SAGs. The relative antenna calibration error between the number of SAGs may comprise the relative antenna calibration errors for UL and/or DL. The compensation may be performed by multiplying DL data with the relative antenna calibration error for DL and/or multiplying UL data with the relative antenna calibration error for UL.

According to some embodiments herein, the network node is configured to calculate the relative antenna calibration error between the number of SAGs for each SAG based on the estimated channel data matrix by being configured to:
calculate a covariance matrix on the combined channel data matrix for each SAG for a number of measurements;
calculate an average of the covariance matrices of all SAGS;
estimate angle-of-arrive or angle-of-departure based on the averaged covariance matrix to obtain a steering vector;
rotate the combined channel data matrix to a boresight position for each SAG by multiplying the combined channel data matrix with the conjugate of the steering vector to get a modified channel data matrix;
calculate an average value of the modified channel data matrix for each SAG; and
calculate the relative antenna calibration error between the number of SAGs for each SAG by dividing the average value of the modified channel data matrix for each SAG with a reference value.

According to some embodiments herein, the received signal from the UE may be an up-link refence signal, or a signal contains channel-state information derived from a reference signal sending from the network node to the UE, or a signal contains down-link channel data matrix.

According to some embodiments herein, the second step calibration may be running periodically.

According to some embodiments herein, the compensation values for the number of antenna subarrays comprised in each SAG may be estimated during production line test and stored in database of the network node. An orthogonal frequency-division multiplexing (OFDM) based calibration signal with K subcarriers may be used during the production line test with a radio distribution network (RDN) board, or over-the-air (OTA) in an anechoic chamber. A phase/amplitude may be estimated for the number of antenna subarrays comprised in each SAG at a subcarrier k, wherein k=1, . . . , K, to obtain the compensation values.

According to some embodiments herein, the number of antenna subarrays and a shape of the antenna subarray in each SAG may be arranged based on the configuration of the transceiver chipsets and required resolution in spatial domain.

According to some embodiments herein, the antenna subarrays are coupled to power amplifiers or low noise amplifiers via antenna switches, and the network node may further comprise a number of switch and power splitter chains arranged between the transceiver chipsets and the power amplifiers and low noise amplifiers. The number of switch and power splitter chains are configured such that the number of antenna subarrays and the shape of the antenna subarray in each SAG is arranged adaptively based on the configuration of the transceiver chipsets and required angular resolution at azimuth and elevation directions.

According to some embodiments herein, a number of switch and power splitter chains are comprised inside the number of transceiver chipsets, and the number of antenna subarrays and the shape of the antenna subarray in each SAG is arranged adaptively based on the configuration of the transceiver chipsets and required resolution in spatial domain by setting the switches in the number of switch and power splitter chains.

According to some embodiments herein, a computer program product comprising program code which when the program is executed by a computer, cause the computer to carry out the method described above for antenna calibration.

In other words, the AC method provided herein is an enhanced in-filed AC solution for massive MIMO radio unit without any help from the conventional AC. Compared with the conventional AC solutions, in-field AC is a relatively new solution. It can avoid the drawbacks of the conventional AC solutions. However, in-field AC relies on AoA or AoD estimation based on the estimated CSI and needs a rough calibration by the conventional AC to start the CSI estimation. If the conventional AC is hindered, the deployment of in-field AC is also impractical because the initial AoA or AoD estimation is not feasible due to the huge phase misalignment i.e. random starting phase of the radio unit.

Thanks to the fast-growing semiconductor industry, more and more RF chains can be integrated into one transceiver (TRX) chipset. It is seen that the starting phase of the antennas relating to one TRX chipset is indeed deterministic, because the TRX chipset uses one single phase locked loop (PLL) for up/down conversion of the signals to/from Radio Frequency (RF). The enhanced in-filed AC solution according to embodiments herein is based on this feature.

Therefore, the antenna array is arranged into several subarray groups (SAGs). Each SAG connects to one TRX chipset. The starting phases of the antenna subarrays in one SAG are measured on the production line test and the compensation values are calculated based on the starting phases and stored in the network node database. These starting phases are compensated in baseband based on the compensation values during a system power-up. The starting phase differences between the antenna subarrays in one SAG are thus removed or reduced. Consequently, a beam space processing for AoA or AoD estimation on the estimated CSI can be performed for antenna subarrays in each SAG.

In-field AC on each SAG runs independently. The covariance matrices calculated on the estimated CSI for multiple SAGs are averaged, that can further reduce the variance of AoA or AoD estimation. A subspace method for AoA or AoD estimation may be used to achieve good performance and low complexity. Once the AoA or AoD estimation is obtained, the AC errors between SAGs can be extracted by removing the pointing-like errors. Moreover, this step may run periodically to track and compensate the phase drifts over the time.

It is noted that the proposed AC method is applicable in both DL AC and UL AC. In the UL AC, the CSI is estimated on the UL reference signal received by the network node. That implies the network node can acquire the UL CSI directly. As for the DL AC, since the CSI is estimated on the DL reference signal received by the UE, the estimated CSI by the UE must be fed back to the network node. Therefore, an extra channel feedback is needed to provide DL CSI for the network node. This may be achieved by an iterative precoding matrix index (PMI) reporting that can feedback highly accurate CSI in an efficient way. Once the CSI is acquired by the network node, the process in the UL AC can be used in DL AC as well.

After completion of the proposed calibration for both UL AC and DL AC, the massive MIMO radio unit can be fully calibrated, even without any help from the conventional AC.

The AC method according to embodiments herein provides some advantages compared to the conventional AC solutions, such as:

Empowered by the enhanced in-field AC for massive MIMO radio unit, the functionalities such as beamforming, nulling beam, or other beam related processing, can work properly in the field.

No need for RND board or coupler network, so the cost is saved.

Avoiding interruption to the traffic data.

Applicable in split antenna array with high isolation between TX and RX antennas.

May be used for totally uncalibrated radio units.

Seeing the true performance on the operating network without impact from calibration path.

Calibrating periodically to track phase drifts over the time.

Supporting SBFD operation in a massive MIMO unit.

Therefore, embodiments herein provide an improved network node and method therein for antenna calibration in a wireless communication system.

### BRIEF DESCRIPTION OF THE DRAWINGS

Examples of embodiments herein are described in more detail with reference to the attached drawings in which:

FIG. 1 is a schematic block diagram illustrating a wireless communication system;

FIG. 2 is a simplified block diagram illustrating a cellular communication network in the field with a massive MIMO radio unit;

FIG. 3 are diagrams illustrating starting phases of four SAGs after multiple power-up cycles;

FIG. 4 is a schematic block diagram illustrating an example configuration of SAGs each with 2×2×1 subarrays;

FIG. 5 is a schematic block diagram illustrating an example configuration of SAGs each with 2×4×1 subarrays;

FIG. 6 is a schematic block diagram illustrating an example configuration of SAGs each with 4×2×1 subarrays;

FIG. 7 is a schematic block diagram illustrating an example configuration of flexible connection between TRXs and antenna subarrys;

FIG. 8 is a flow chart illustrating a method for antenna calibration according to embodiments herein;

FIG. 9 is a block diagram illustrating a network node in which a method for antenna calibration according to embodiments herein may be implemented;

FIG. 10 shows comparison of the method for antenna calibration according to embodiments herein in different scenarios.

### DETAILED DESCRIPTION

Embodiments herein relate to a communications system in general. FIG. 1 is a schematic overview depicting a communication system 100. In a typical wireless communication system, wireless devices, also known as wireless communication devices, mobile stations, and/or user equipment (UE), communicate via a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (BS), which in some networks may also be denoted, for example, a “NodeB” or “eNodeB” or “eNB” or “gNodeB” or “gNB”. A service area or cell area is a geographical area where radio coverage is provided by the radio network node.

The communication system 100 may comprise one or more RANs. The communication system 100 may use a number of different technologies such as Global System for Mobile communications/enhanced Data rate for GSM Evolution (GSM/EDGE), Wideband Code Division Multiple Access (WCDMA), Worldwide Interoperability for Microwave Access (WiMax), Ultra Mobile Broadband (UMB), Wi-Fi, Long Term Evolution (LTE), LTE-Advanced, New Radio (NR) etc., just to mention a few possible implementations.

In the wireless communication system 100, one or more wireless communication devices 130, 131 such as a UE, a mobile station or a wireless terminal communicates via one or more RANs to one or more CNs. It should be understood by the skilled in the art that “wireless communication device” is a non-limiting term which means any terminal, wireless communication terminal, user equipment, Machine Type Communication (MTC) device, Device to Device (D2D) terminal, or any other nodes or devices in the wireless communication system 100, e.g. smart phone, laptop, mobile phone, sensor, relay, mobile tablets or even a small base station communicating within a cell.

Network nodes operate in the wireless communication system 100 such as a network node 110. The network node 110 may be any of RAN node, such as gNB, eNB, en-gNB, ng-eNB, gNB etc. The network node 110 provides radio coverage over a geographical area, a service area 11, which may also be referred to as a beam or a beam group where the group of beams is covering the service area of a radio access technology (RAT), such as 5G, LTE, NR or similar. The network node 110 may be a transmission and reception point e.g. a radio access network node such as a Wireless Local Area Network (WLAN) access point or an Access Point Station (AP STA), an access controller, a base station, e.g. a radio base station such as a NodeB, a gNodeB or gNB, an evolved Node B (eNB or eNodeB), a base transceiver station, a radio remote unit, an Access Point Base Station, a base station router, a transmission arrangement of a radio base station, a stand-alone access point or any other network unit capable of communicating with a wireless communication device within the service area served by the network node 110 depending e.g. on the radio access technology and terminology used.

In order to find an improved AC method, in-field AC is proposed and investigated. In-field AC relies on angle-of-arrival (AoA) estimation of over-the-air (OTA) channel-state information (CSI). In wireless communications, CSI refers to the channel properties of a communication link. This information describes how a signal propagates between a transmitter and a receiver. In-field AC extracts antenna impairments from the CSI of an end-to-end channel, i.e. the communication channel from a transmitter to a receiver or from a receiver to a transmitter, by removing the OTA CSI which is reconstructed from the AoA estimation. In another word, the accuracy of AoA estimation is crucial to the result of in-field AC. For example, in a coarse-calibrated radio system, it may have a decent accuracy of AoA estimation. However, it may have problem in an uncalibrated radio system because the initial AoA estimation is not feasible due to the huge phase misalignment i.e. random starting phase of the radio system. Therefore, in-field AC can only be employed as an online verification to check the actual AC errors, and it cannot be used to calibrate the uncalibrated radio system e.g. the radio system after power off and on.

Therefore, although in-field AC may avoid the drawbacks of the conventional AC solutions, it needs a rough calibration by the conventional AC to start CSI estimation. If the conventional AC is hindered, the deployment of in-field AC is also impractical.

According to embodiments herein, an enhanced in-field AC solution for massive MIMO radio unit without any help from the conventional calibration way is provided.

Thanks to the fast-growing semiconductor industry, more and more RF chains can be integrated into one transceiver (TRX) chipset. It is observed that the starting phase of the antennas relating to one TRX chipset is indeed deterministic, because the TRX chipset uses one single phase locked loop (PLL) for up/down conversion of the signals to/from RF. A method according to embodiments herein for antenna calibration in a wireless communication system is developed based on this observation.

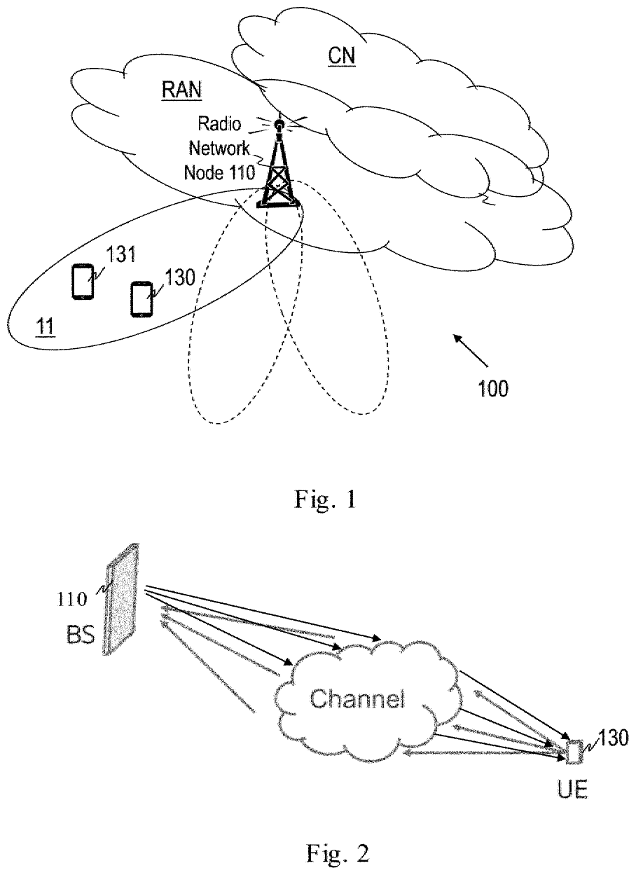

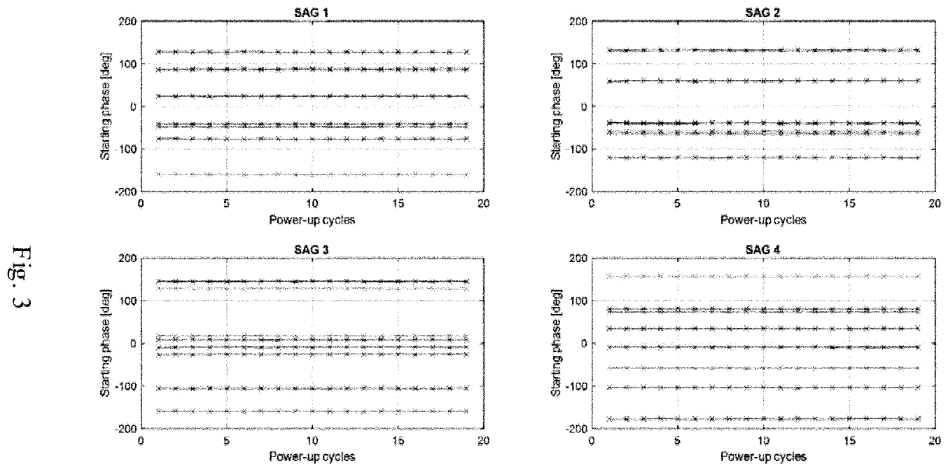

FIG. 2 illustrates a simplified wireless communication system 100, where a cellular network in the field with MIMO radio is shown. In the UL, a UE 130 transmits a signal, the signal propagates through the wireless channel, the network node 110, e.g. a base station (BS) receives the signal. In the DL, BS 110 transmits a signal, the signal propagates through the wireless channel, UE 130 receives the signal. In general, the wireless channel introduces reflection, diffraction and scattering that creates multiple propagation paths between the transmitter and the receiver, each with a different delay and a different angle. In-field AC handles these effects in beam space. Due to that, it needs the help from the conventional AC, especially MC AC, to enable the beam space processing for AoA or AoD estimation being performed on CSI.

The network node 110 may be a massive MIMO radio unit and comprise an antenna array and a number of transceiver chipsets. The antenna array comprises a number of subarrays which are arranged in a number P of subarray groups (SAGs). The number P of SAGs are coupled to the number of transceiver chipsets respectively. For example, the antenna array comprises M×N×D subarrays, where M, N, and D denote the number of rows, columns, and polarizations of the antenna array, respectively. Each SAG contains a number m×n×1 of antenna subarrays, so P=2MN/mn, when the polarization of the antenna is 2, i.e. D=2, where m and n denote the number of rows and columns of the antenna subarrays in each SAG, respectively, and 1 means there is one polarization in each SAG. Each antenna subarray may contain many antenna elements.

From study in the massive MIMO radio unit, it is observed that the starting phases between antenna subarrays connecting to one TRX chipset are deterministic in every power-up cycle. These starting phases are caused by hardware imperfection such as part-to-part variation, traces on printed circuit boards, nonlinearities in the components, etc. which can be characterized in the production line. During run-time due to environmental condition and due to aging, the phases between antenna subarrays may have additional phase offsets from the production. These phase offsets are generally small, much smaller than the starting phase differences between TRX chipsets. Accordingly, it is proposed to split the whole antenna array into several subarray groups (SAGs), while each SAG connects to one TRX chipset. It is noted that two antenna polarizations can be processed as two separate groups, due to that one SAG may only contain the antenna subarrays from one polarization.

In the following, the terms “network node”, “BS”, “MIMO radio unit”, “radio unit”, “massive MIMO radio unit” may be used interchangeably.

FIG. 3 depicts the starting phases between the antenna subarrays in one SAG after multiple power-up cycles, wherein SAG 1 relates to a first TRX chipset TRX 1, and SAG 2 relates to a second chipset TRX 2, and so forth. The measurement is carried out on a massive MIMO radio prototype with 64 antenna subarrays, i.e. 32 antenna subarrays per polarization. One TRX chipset can support 8 Tx chains and 8 Rx chains. In total, there are 4 SAGs for one polarization, and 8 SAGs for two polarizations. Only the results of one polarization are plotted in the figure, indicted by SAG 1, SAG 2, SAG 3 and SAG 4. There are 8 lines in each SAG representing the starting phases of the 8 subarrays in this SAG. It is seen that the starting phases of the antenna subarrays in one SAG are deterministic after every system power-up. The common phase of each SAG has been removed before plotting, therefore the random starting phase between four SAGs are not seen in the figure.

The observation mentioned above sets the foundation of the proposed enhanced in-filed AC method according to embodiments herein.

In the following, an example massive MIMO radio unit comprising an antenna array composed of 4×8×2 subarrays and TRX chipsets supporting 64 RF chains will be discussed to illustrate how to configure SAGs depending on required angular resolution at azimuth and elevation directions. Noteworthily, one antenna subarray may contain multiple physical antenna elements to strengthen its directivity. On the other hand, two polarizations can be measured separately, therefore the principle is disclosed and discussed on one polarization, but it should be applied on two polarizations equally.

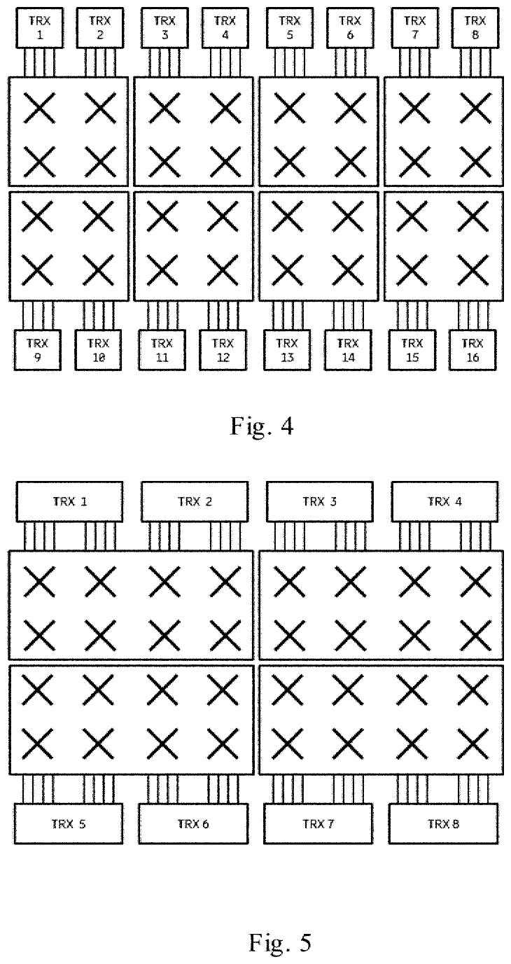

FIG. 4 illustrates an example configuration of the massive MIMO radio unit, where the whole antenna array is split into 16 SAGs, each SAG contains 2×2×1 subarrays. In the figure, one rectangle contains two SAGs, one SAG for polarization 45°, one for polarization −45°. One TRX chipset supporting 4 TX chains and 4 RX chains are connected to one SAG. Two TRX chipsets are plotted for two polarizations. For instance, TRX 1 connects to 2×2×1 subarrays with 45° polarization, and TRX 2 connects to 2×2×1 subarrays with −45° polarization. Other SAGs are implemented in a similar manner.

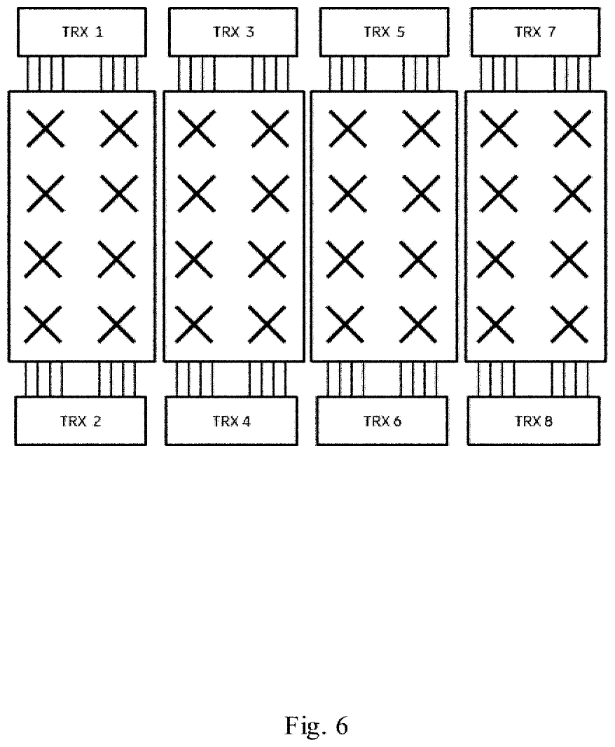

FIGS. 5 and 6 show another realization in which one TRX chipset can support 8 TX chains and 8 RX chains. It is noted that, in FIGS. 5 and 6, one rectangle also contains two SAGs, one SAG for polarization 45° and one for polarization-45°. Accordingly, the whole antenna array is split into 8 SAGs, and each SAG contains 8 subarrays. In this case, the SAG may be configured to either 2×4×1=8 subarrays or 4×2×1=8 subarrays, depending on the resulting angular resolution at azimuth and elevation directions. FIG. 5 illustrates an example configuration of the massive MIMO radio unit with 2×4×1=8 subarrays in each SAG and FIG. 6 illustrates an example configuration of the massive MIMO radio unit with 4×2×1=8 subarrays in each SAG.

It is noted that FIGS. 4,5,6 are just examples to explain the principle of embodiments herein. The antenna array may have any number of antennas with any array configuration. And one TRX chipset may support any number of antennas, depending on the scale of chipset. These examples can be extended to other cases in a similar way.

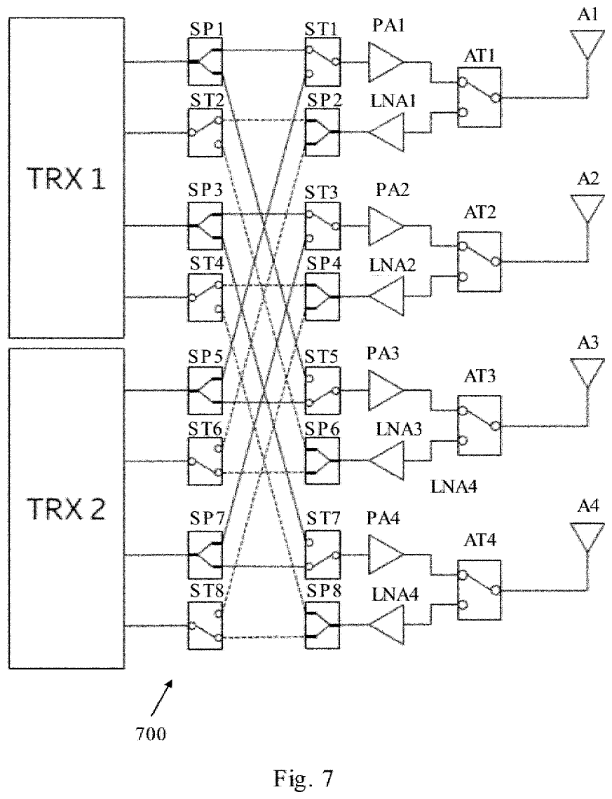

To adapt to different application scenarios, a flexible connection between antenna arrays and TRX chipsets may be implemented. FIG. 7 illustrates an example massive MIMO radio unit 700 that comprises four antenna subarrays A1, A2, A3, A4 and two TRX chipsets TRX 1, TRX 2. Each TRX chipset supports 2 TX chains and 2 RX chains. As shown, TRX 1 chipset supports 2 TX chains comprising a first Power Amplifier (PA) PA1 and a second PA PA2 and 2 RX chains comprising a first Low Noise Amplifier (LNA) LNA1 and a second LNA LNA2. TRX 2 chipset supports 2 TX chains comprising a third and fourth PAS PA3, PA4 and 2 RX chains comprising a third and fourth LNAs LNA3, LNA4. Note that this is just an example, and the proposal may be applied to generic cases with more antenna arrays and more TRX chipsets.

In this example, the antenna subarrays A1, A2, A3, A4 are coupled to PAs or LNAs via respective antenna switches AT1, AT2, AT3, AT4. A number of switch (ST) and power splitter (SP) chains are arranged between the PAs/LNAs and TRX chipsets. Each switch and power splitter chain, STi, SPi, i=1, . . . 8, comprises a switch and a power splitter. The PAs/LNAs are connected to the TRX chipsets via the respective switch and power splitter chains. The connection from an antenna array to a TRX chipset is selected by switching the switches ST1, ST2, . . . . ST8 in the switch and power splitter chains. As shown in the figure, this switching is done before PA in the TX chain and after LNA in the RX chain, leading to low impact on insertion loss and noise figure, respectively. With different settings in the switch and power splitter chains, the shape of a SAG can be formed adaptively to achieve the required or desired resolution in spatial domain. For example, all four antenna subarrays A1, A2, A3, A4 may be arranged in one SAG and connected to TRX 1 or TRX 2, or may be arranged in two SAGs and connected to TRX 1 and TRX 2 respectively.

Therefore, according to some embodiments herein, the number of antenna subarrays and a shape of the antenna subarray in each SAG may be arranged based on the configuration of the transceiver chipsets and required resolution in spatial domain.

According to some embodiments herein, the network node 110 may comprise a number of switch and power splitter chains arranged between the transceiver chipsets and the power amplifiers and low noise amplifiers. The number of switch and power splitter chains are configured such that the number of antenna subarrays and the shape of the antenna subarray in each SAG is arranged adaptively based on the configuration of the transceiver chipsets and required angular resolution at azimuth and elevation directions.

FIG. 7 is just an example where the number of switch and power splitter chains are located outside the TRX chipsets. According to some embodiments herein, the number of switch and power splitter chains may be comprised inside the TRX chipsets and the number of antenna subarrays and the shape of the antenna subarray in each SAG may be arranged adaptively based on the configuration of the transceiver chipsets and required resolution in spatial domain by setting the switches in the number of switch and power splitter chains.

By splitting antenna array into subarrays and arranging the antenna subarrays to SAGs and connecting SAGs to respective TRX chipsets, the antenna subarrays in one SAG can have deterministic starting phases. These starting phases may be measured, and a compensation value may be calculated during production line test for each SAG when the radio unit is manufactured. The compensation value represents relative phase and amplitude differences between the antenna subarrays in the same SAG. The compensation values for all SAGs may be calculated and stored in database of the radio unit. During system power-up, the network node software loads these values and compensates the phase and amplitude differences between the antenna subarrays in each SAG. Once this calibration is accomplished, the estimation of AoA or AoD can be carried out for each SAG.

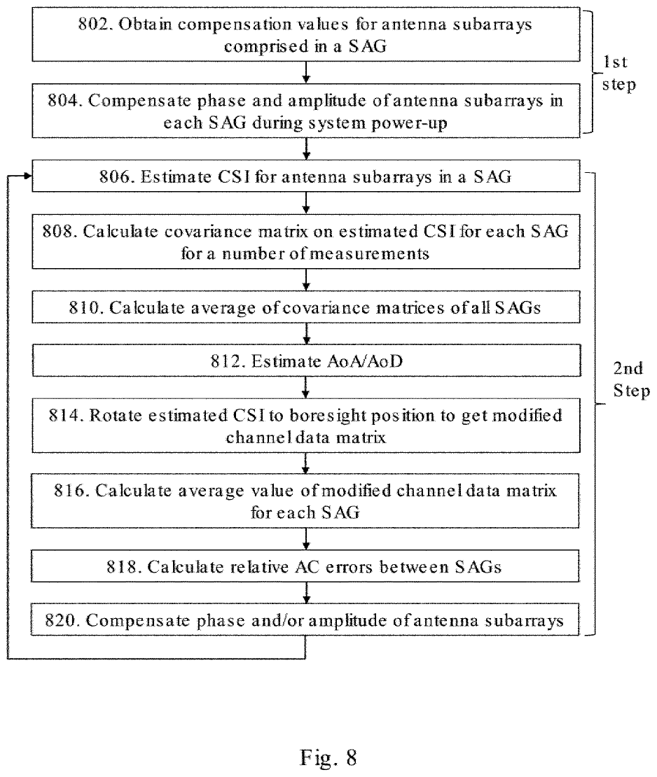

A method performed by a network node 110 in a wireless communication system 100 for antenna calibration will be described with reference to FIG. 8. As described above, the network node 110 comprises an antenna array and a number of transceiver chipsets. The antenna array comprises a number of subarrays which are arranged in a number P of subarray groups (SAGs). The number of SAGs are coupled to the number of transceiver chipsets respectively. For example, the antenna array comprises M×N×D subarrays, where M, N, and D denote the number of rows, columns, and polarizations of the antenna subarrays, respectively. Each SAG contains a number m×n×1 of antenna subarrays, so P=2MN/mn, when the polarizations of the antenna is 2, i.e. D=2, where m and n denote the number of rows and columns of the antenna subarrays in each SAG, respectively, and there may be one or two polarization in each SAG.

The method comprises a two-step calibration.

The first step is to remove or reduce the relative phase and/or amplitude differences between the antenna subarrays within each SAG. These relative phases and/or amplitudes are deterministic and can be compensated during system power-up. The second step is to remove or reduce the relative phase differences between SAGs. Because the LO of TRX chipset needs to be re-synchronized in every power-up cycle, these relative phases between SAGs look like some random variables. It is hard to compensate them by conventional way. However, it can run AoA/AOD estimation based on CSI for each SAG and find out the right AoA/AOD of UE. As long as the AoA/AOD of UE is calculated, the relative phases between SAGs can be obtained by removing the pointing-like errors. Furthermore, the second step calibration may be run periodically over the time to track the phase drifts due to such as temperature changes.

During the first step calibration, the method comprises the following actions.

### Action 802

The network node 110 is configured to obtain compensation values for the number of antenna subarrays comprised in each SAG at a system power-up. The compensation values represent relative phase and amplitude differences between the antenna subarrays in the same SAG for two or more subcarriers. The compensation values comprise down-link (DL) and up-link (UL) compensation values for the two or more subcarriers.

The compensation values for the number of antenna subarrays comprised in each SAG may be stored in database of the network node 110 and the network node 110 may obtain the compensation values by loading these compensation values at a system power-up.

The compensation values for the number of antenna subarrays comprised in each SAG may be estimated during production line test and stored in database of the network node 110.

An orthogonal frequency-division multiplexing (OFDM) based calibration signal with K subcarriers may be used during production line test with a radio distribution network (RDN) board, or over-the-air (OTA) in an anechoic chamber. The calibration signal has K subcarriers, spanning the full bandwidth of interest.

During the test, phase and amplitude are estimated for the number of antenna subarrays comprised in each SAG at subcarrier k, wherein k=1, . . . , K, to obtain the compensation values.

The phase and amplitude estimation is carried out on each SAG independently, and for both TX or DL and RX or UL.

The estimated phase and amplitude vector for TX/DL and RX/UL at subcarrier k for the pth SAG may be represented as:

$${TX}^{p} ( k ) = {[ \begin{matrix}{TX}_{1 , 1}^{p} ( k ) & {TX}_{2 , 1}^{p} ( k ) & … & {TX}_{i , j}^{p} ( k ) & … & {TX}_{m , n}^{p} ( k )\end{matrix} ]}^{T}$$

$${RX}^{p} ( k ) = {[ \begin{matrix}{RX}_{1 , 1}^{p} ( k ) & {RX}_{2 , 1}^{p} ( k ) & … & {RX}_{i , j}^{p} ( k ) & … & {RX}_{m , n}^{p} ( k )\end{matrix} ]}^{T}$$

Where, the antenna subarray of the pth SAG is denoted as m×n×1, where m and n are the number of rows and columns in one SAG, respectively.

$${TX}_{i , j}^{p} ( k )$$

represents phase and amplitude value of the antenna subarray in the ith raw and jth column of the pth SAG. [ . . . ]^{T} is the transpose of a vector.

The compensation values for the antenna subarrays in one SAG at subcarrier k may be calculated by dividing the estimated phase and amplitude value of each antenna subarray with an averaged phase and amplitude value of all antenna subarrays in one SAG, expressed as:

$${\overline{TX}}^{p} ( k ) = \frac{{TX}^{p} ( k )}{\frac{1}{mn} {\sum }_{i , j} T {X}_{i , j}^{p} ( k )} ,$$

$${\overline{RX}}^{p} ( k ) = \frac{{RX}^{p} ( k )}{\frac{1}{mn} {\sum }_{i , j} {RX}_{i , j}^{p} ( k )} .$$

Where

$$\frac{1}{mn} {\sum }_{i , j} {TX}_{i , j}^{p} ( k )$$

is the averaged phase and amplitude value of all antenna subarrays in one SAG for UL,

$$\frac{1}{mn} {\sum }_{i , j} {RX}_{i , j}^{p} ( k )$$

is the averaged phase and amplitude value of all antenna subarrays in one SAG for DL. T̅X̅^{p}(k) and R̅X̅^{p}(k) are compensation values at subcarrier k for UL and DL respectively and represent relative phase and amplitude differences between the antenna subarrays in the same SAG.

The compensation values T̅X̅^{p}(k) and R̅X̅^{p}(k) may be stored in database in the network node 110. To save the storage space, not all compensation values for all subcarriers are necessarily stored. Typically, a few compensation values, e.g. at two or more subcarriers are stored, and un-stored subcarriers may be interpolated by the stored subcarriers.

Therefore, according to some embodiments herein, the network node 110 may be configured to obtain the compensation values for other subcarriers than the two or more stored compensation values by interpolating the stored compensation values for the two or more subcarriers.

### Action 804

During the system power-up, inverse values of the compensation values T̅X̅^{p}(k) and R̅X̅^{p}(k), i.e. 1/T̅X̅^{p}(k) and 1/R̅X̅^{p}(k), may be computed and used to compensate impairment of radio units. This compensation is generally performed in baseband. Denoting a transmitted signal or DL data at the baseband at subcarrier k for the antenna subarray in the ith raw and jth column of the pth SAG as

$${t}_{i , j}^{p} ( k ) ,$$

the compensation for transmitter, i.e. for DL signal, can be written as:

$${\tilde{t}}_{i , j}^{p} ( k ) = \frac{{t}_{i , j}^{p} ( k )}{{\overline{TX}}_{i , j}^{p} ( k )} .$$

Similarly, denoting a received signal or UL data at the baseband at subcarrier k from the antenna subarray in the ith raw and jth column of the pth SAG as

$${r}_{i , j}^{p} ( k ) ,$$

the compensation for receiver, i.e. for UL signal, can be written as:

$${\tilde{r}}_{i , j}^{p} ( k ) = \frac{{r}_{i , j}^{p} ( k )}{{\overline{RX}}_{i , j}^{p} ( k )}$$

Therefore, according to embodiments herein, the network node 110 is configured to compensate phase and amplitude of the antenna subarrays in each SAG based on the compensation values during a system power-up by multiplying the DL and/or UL data with the DL and/or UL compensation values respectively for the number of antenna subarrays comprised in each SAG.

After this compensation step, the relative phases and amplitudes differences between all antenna subarrays within each SAG are roughly removed or reduced.

Note that the first step calibration may not be accurate enough due to the changes of such as temperature drifts or hardware aging etc. However, it may be good enough because relatively large AC errors within each SAG may be handled during the second-step calibration.

Thanks to the first-step calibration, the AoA and AoD estimation can then be performed based on each SAG respectively. During a second step calibration, the method comprises the following actions:

### Action 806

The network node 110 is configured to estimate CSI for the number of antenna subarrays in a SAG at a subcarrier k based on a received signal from a UE.

According to some embodiments herein, the received signal from the UE may be an up-link refence signal, or a signal contains channel-state information derived from a reference signal sending from the network node 110 to the UE 130, or a signal contains down-link channel data matrix. The signal contains channel-state information derived from a reference signal sending from the network node 110 may be a compressed CSI, and the signal contains down-link channel data matrix may be a full CSI.

Suppose that the DL channel from the antenna subarray in the ith raw and jth column of the pth SAG to the UE at a subcarrier k is denoted by

$$D {L}_{i , j}^{p} ( k ) ,$$

and the UL channel from the UE to the antenna subarray in the ith raw and jth column of the pth SAG is denoted by

$${UL}_{i , j}^{p} ( k ) ,$$

the estimated CSI may be represented by a combined channel data matrix comprising channel data contributed from the DL/UL communication channel between the network node and UE

$$D {L}_{i , j}^{p} ( k ) , {UL}_{i , j}^{p} ( k ) ,$$

and the channel data contributed from DL/UL antenna calibration error of the antenna subarray in the ith raw and jth column of the pth SAG, denoted as

$$T {X}_{i , j}^{p} ( k ) , R {X}_{i , j}^{p} ( k ) ,$$

which are the residual antenna calibration error in phase and/or amplitude after the first step calibration.

$${H}_{i , j}^{p , DL} ( k ) = D {L}_{i , j}^{p} ( k ) {TX}_{i , j}^{p} ( k ) ,$$

$${H}_{i , j}^{p , UL} ( k ) = R {X}_{i , j}^{p} ( k ) {UL}_{i , j}^{p} ( k )$$

So, the estimated channel-state information may be represented by a combined channel data matrix comprising channel data contributed from a communication channel between the network node and user equipment and channel data contributed from antenna calibration error between the number of antenna subarrays comprised in the antenna array.

After the channel-state information is estimated, the network node 110 is configured to calculate a relative antenna calibration error between the number of SAGs for each SAG based on the estimated channel data matrix which may comprise the following actions.

### Action 808

To get the antenna calibration errors of the antenna subarrays, it needs to extract

$$T {X}_{i , j}^{p} ( k ) from {H}_{i , j}^{p , DL} ( k ) , and {RX}_{i , j}^{p} ( k ) from {H}_{i , j}^{p , UL} ( k ) .$$

This can be accomplished by incorporating angular based model into the channel estimation. The method is explained for UL channel but can also be applied to DL channel, as long as the UE 130 can feed back the accurate channel data to the network node 110. Due to that, the superscript DL or UL is omitted here in the following descriptions.

The estimated CSI of the antenna subarrays in a SAG, e.g. in the pth SAG can be written as:

$${H}^{p} ( k ) = [ {\begin{matrix}{H}_{1 , 1}^{p} ( k ) & {H}_{2 , 1}^{p} ( k ) & … & {H}_{i , j}^{p} ( k ) & … & {H}_{m , n}^{p} ( k ) ]\end{matrix}}^{T} .$$

Here, H^{p}(k) represents the CSI of one measurement, which is also referred to as one snapshot. To have full rank matrix, Q measurements or snapshots should be accumulated, where Q>>mn.

Accordingly, the network node 110 may be configured to calculate a covariance matrix on the estimated CSI, i.e. the combined channel data matrix, for each SAG for a number Q of measurements, which is expressed by:

$${C}^{p} ( k ) = \frac{1}{Q} {\sum }_{t = 1}^{Q} {H}^{p} ( k , t ) {{H}^{p} ( k , t )}^{*}$$

Here, (⋅)* represents the conjugate transpose of a vector.

Note that C^{p}(k) is estimated for the pth SAG. The C^{p}(k) estimates from all SAGs are averaged to further minimize the variance.

### Action 810

The network node 110 may be configured to calculate an average of the covariance matrices of all SAGs, i.e. p=1, 2, . . . . P, expressed as:

$$C ( k ) = \frac{1}{P} {\sum }_{p = 1}^{P} {C}^{p} ( k )$$

### Action 812

The network node 110 may be configured to estimate angle-of-arrive (AoA) for UL channel, or angle-of-departure (AoD) for DL channel, based on the averaged covariance matrix to obtain a steering vector.

A subspace method may be used to estimate AoA or AoD which depends on the eigenvalue decomposition of C(k), which is done on each subcarrier k, that is

$$C ( k ) = V ( k ) D ( k ) {V ( k )}^{*} .$$

Where, V(k) is a matrix whose columns are the corresponding right eigenvectors of C(k), D(k) is a diagonal matrix comprising eigenvalues of C, and V(k)* denotes the conjugate transpose of the matrix V(k). The full space of C(k) is composed of a signal subspace Vₛ(k) and a noise subspace Vₙ(k), where Vₛ(k) denotes the eigenvectors with the largest eigenvalues, and Vₙ(k) denotes the eigenvectors with the smallest eigenvalues. Generally, how to dimension the signal subspace and the noise subspace is a tough problem for any subspace method. Fortunately, it doesn't bother here because it just needs to find out the strongest incoming signal. That means the dimension of the signal subspace is 1, i.e.

$${V}_{s} ( k ) = {V}_{1} ( k ) ,$$

$${V}_{n} ( k ) = {V}_{2 : mn} ( k ) .$$

Where, V₁(k) is the first column vector of the matrix V(k). V_{2:mn}(k) are the column vectors of the matrix V(k) from the second to the last.

On the other hand, the steering vector for AoA/AOD is denoted by A(θ, φ), which is a spherical coordinate describing a vector or point in space (x, y, z) with a distance A and two angles θ and φ. The φ angle is the angle from the positive y-axis to the vector's orthogonal projection onto the yz plan, and the 0 angle is the angle from the x-axis to the vector itself.

Accordingly, the estimated AoA/AOD can be expressed as:

$$\tilde{θ} ( k ) , \tilde{ϕ} ( k ) = {max arg}_{θ , ϕ} \frac{1}{{\sum }_{l = 2}^{mn} {\vert A ( θ , ϕ ) * {V}_{l} ( k ) \vert}^{2}}$$

Here, V₁(k), l=2:mn, denote the supporting vectors of noise subspace. A(θ, φ) is the steering vector of a signal comes from or goes to with the true angles (θ, φ). Ideally, the steering vector associated with the true angles (θ, φ) is supposed to be perpendicular to the noise subspace. That means the inverse of correlation between the steering vector and the noise subspace will achieve the maximum if the estimated angles \tilde{θ}(k), (k) are equal to the true angles (θ, φ). The purpose of this equation is to find out the angles give the maximum value and use them as the estimated angle \tilde{θ}(k), φ̅(k).

Note that the estimated AoA/AOD, θ̅(k), φ̅(k), is obtained at the subcarrier k. Obviously, the AoA/AOD of UE is a frequency-independent parameter. For this reason, the true AoA/AOD can be computed by averaging the estimated AoA/AoD θ̅(k), φ̅(k) over all subcarriers, that is:

$$\tilde{θ} , \tilde{ϕ} = \frac{1}{K} {\sum }_{k = 1}^{K} \tilde{θ} ( k ) , \tilde{ϕ} ( k ) .$$

### Action 814

Once the AoA/AOD, θ̅, φ̅ is obtained, the estimated CSI of the antenna subarrays in a SAG is rotated to a boresight position.

The network node 110 may be configured to rotate the estimated CSI, i.e. the combined channel data matrix, to the boresight position for each SAG by multiplying the combined channel data matrix with the conjugate of the steering vector to remove pointing-like error, and a modified channel data matrix is obtained:

$${\tilde{H}}^{p} ( k ) = {A ( \tilde{θ} , \tilde{ϕ} )}^{*} {H}^{p} ( k ) .$$

The modified channel data matrix is written as:

$${\tilde{H}}^{p} ( k ) = {[ {\tilde{H}}_{1 , 1}^{p} ( k ) {\tilde{H}}_{2 , 1}^{p} ( k ) … {\tilde{H}}_{i , j}^{p} ( k ) … {\tilde{H}}_{m , n}^{p} ( k ) ]}^{T} .$$

### Action 816

Right now, since only the AC errors between SAGs are considered in the second step calibration, to get more stable result, the CSI values in the modified channel data matrix for a SAG are averaged. That is the network node 110 may be configured to calculate an average value of the modified channel data matrix for each SAG:

$${E}^{p} ( k ) = \frac{1}{m n} {\sum }_{i , j} {\tilde{H}}_{i , j}^{p} ( k ) .$$

### Action 818

The network node 110 may be configured to calculate the relative antenna calibration error between the number of SAGs for each SAG by dividing the average value of the modified channel data matrix for each SAG with a reference value. For example, the relative AC errors between SAGs may be calculated as:

$${\overline{E}}^{p} ( k ) = \frac{{E}^{p} ( k )}{\frac{1}{P} {\sum }_{p} {E}^{p} ( k )} .$$

It is noted that the averaged value over all SAGs,

$$\frac{1}{P} {\sum }_{p} {E}^{p} ( k ) ,$$

is used as the reference value, and all SAGs are aligned to this reference value. Actually, the EP (k) value of any one of SAG may be chosen as the reference value. The result is irrelevant to which one is selected as the reference value.

After the relative antenna calibration error between the number of SAGs for each SAG is calculated, the phase and/or amplitude of the antenna subarrays in each SAG can be calibrated. The method further comprises the following action.

### Action 820

The network node 110 is further configured to compensate phase and/or amplitude of the antenna subarrays in each SAG based on the relative antenna calibration error between the number of SAGs for each SAG by multiplying the DL/UL data with the relative antenna calibration error.

Similarly, this compensation is performed in baseband as described above with regard to the first step calibration. Denoting a transmitted signal or DL data at the baseband at subcarrier k for the antenna subarray in the ith raw and jth column of the pth SAG after the first step calibration as

$${\tilde{t}}_{t , j}^{p} ( k ) ,$$

the compensation for transmitter, i.e. for DL signal, can be written as:

$${\tilde{\tilde{t}}}_{i , j}^{p} ( k ) = \frac{{\tilde{t}}_{i , j}^{p} ( k )}{{\overline{E}}_{i , j}^{p} ( k )} .$$

Similarly, denoting a received signal or UL data at the baseband at subcarrier k for the antenna subarray in the ith raw and jth column of the pth SAG after the first step calibration as

$${\tilde{r}}_{i , j}^{p} ( k ) ,$$

the compensation for receiver, i.e. for UL signal, can be written as:

$${\tilde{\tilde{r}}}_{i , j}^{p} ( k ) = \frac{{\tilde{r}}_{i , j}^{p} ( k )}{{\overline{E}}_{i , j}^{p} ( k )}$$

According to some embodiments herein, the second step calibration of the Actions 806 to 820 may be performed periodically over the time to track and compensate the phase drifts due to e.g., temperature changes.

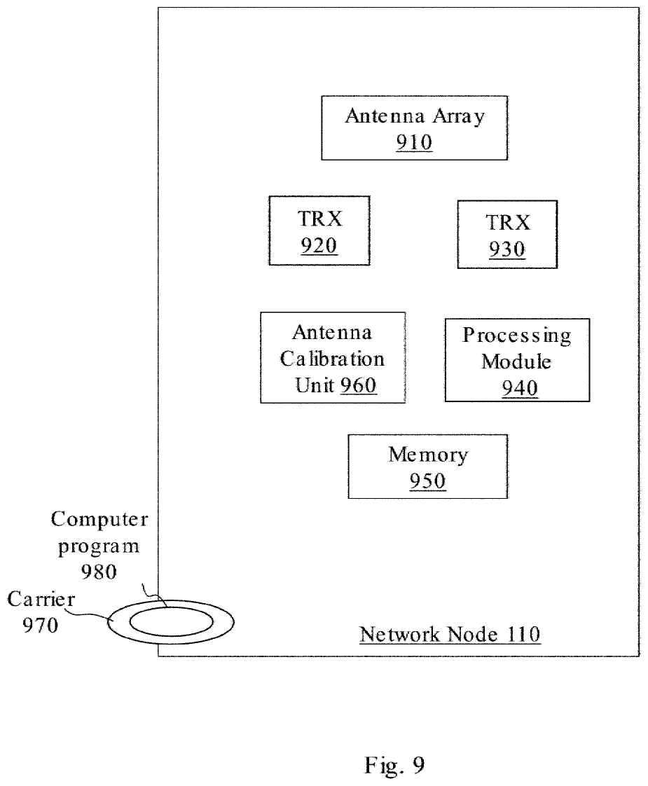

FIG. 9 shows an example of a network node 110 in which the method for antenna calibration may be implemented. The network node 110 may be a base station, for example, an eNB, gNB, eNodeB, gNodeB. The network node 110 may comprise an antenna array 910 comprising a number of antenna subarrays, one or more TRX chipsets 920, 930 for receiving and transmitting signals, a processing module 940 for processing signals, and a memory 950 for storage data, instructions, configurations etc. The network node 110 may further comprise an antenna calibration unit 960 for antenna calibration. The method for antenna calibration may be implemented in the antenna calibration unit 960 or in the processing module 940. The method for antenna calibration may also be implemented through one or more processors in the network node 110 together with computer program code for performing the functions and actions of the embodiments herein. The program code mentioned above may also be provided as a computer program product, for instance in the form of computer readable medium or a data carrier 970 carrying computer program code or instructions 980, as shown in FIG. 9, for performing the embodiments herein when being loaded into the network node 110. One such carrier may be in the form of a CD ROM disc. It is however feasible with other data carriers such as a memory stick. The computer program code may furthermore be provided as pure program code on a server or a cloud and downloaded to the network node 110.

The network node 110 is configured to perform the method Actions 802-820 described above.

For example, the network node 110 is configured to, during a first step calibration, by means of e.g. the processing module 940 or antenna calibration unit 960 being configured to, at a system power-up, obtain compensation values for the number of antenna subarrays comprised in a SAG, wherein the compensation values represent relative phase and amplitude differences between the antenna subarrays in the same SAG for two or more subcarriers.

The network node 110 is further configured to, during the first step calibration, by means of e.g. the processing module 940 or antenna calibration unit 960 being configured to, compensate phase and amplitude for the antenna subarrays in each SAG based on the compensation values during the system power-up.

The network node 110 is further configured to, during a second step calibration, by means of e.g. the processing module 940 or antenna calibration unit 960 being configured to, estimate a channel-state information for the number of antenna subarrays in a SAG at a subcarrier based on a received signal from a UE, wherein the channel-state information is represented by a combined channel data matrix comprising channel data contributed from a communication channel between the network node and user equipment and channel data contributed from antenna calibration error between the number of antenna subarrays comprised in the antenna array.

The network node 110 is further configured to, during a second step calibration, by means of e.g. the processing module 940 or antenna calibration unit 960 being configured to, calculate a relative antenna calibration error between the number of SAGs for each SAG based on the estimated channel data matrix.

The network node 110 is further configured to, during a second step calibration, by means of e.g. the processing module 940 or antenna calibration unit 960 being configured to, compensate phase and/or amplitude for the antenna subarrays in each SAG based on the relative antenna calibration error between the number of SAGs for each SAG.

According to some embodiments herein, the network node 110 is configured to
calculate the relative antenna calibration error between the number of SAGs for each SAG based on the estimated channel data matrix by being configured to:
calculate a covariance matrix on the combined channel data matrix for each SAG for a number of measurements;
calculate an average of the covariance matrices of all SAGS;
estimate angle-of-arrive or angle-of-departure based on the averaged covariance matrix to obtain a steering vector;
rotate the combined channel data matrix to a boresight position for each SAG by multiplying the combined channel data matrix with the conjugate of steering vector to get a modified channel data matrix;
calculate an average value of the modified channel data matrix for each SAG; and
calculate the relative antenna calibration error between the number of SAGs for each SAG by dividing the average value of the modified channel data matrix for each SAG with a reference value.

According to some embodiments herein, the method for antenna calibration may be implemented in a computer program product 970. The computer program product 970 comprises program code 980 which when the program is executed by a computer, cause the computer to carry out the method for antenna calibration as described above.

To verify the effectiveness of the calibration method herein, a BS of massive MIMO radio unit deployed in the field is tested. The MIMO radio unit has 64 RF chains and supports an antenna array with 4×8×2 antenna subarrays. The carrier frequency and the carrier bandwidth are 4.9 GHZ and 100 MHz, respectively. Multiple TRX chipsets supporting 8 TX chains 8 RX chains are employed in the radio unit, which can be configured as 4×2×1 SAG or 2×4×1 SAG. In the meantime, a UE is mounted on a car and move around the BS slowly. It is noted that the channel between UE and BS can be either line-of-sight (LOS) channel or non-line-of-sight (NLOS) channel. Since the angular resolution of the AoA/AOD estimation on each SAG is not high, LOS channel is more preferred than NLOS channel. To get a reliable result, it is critical to remove the bad channels before the computation. The bad channels can be recognized by the channel characteristics such as received power, delay spread or angular spread.

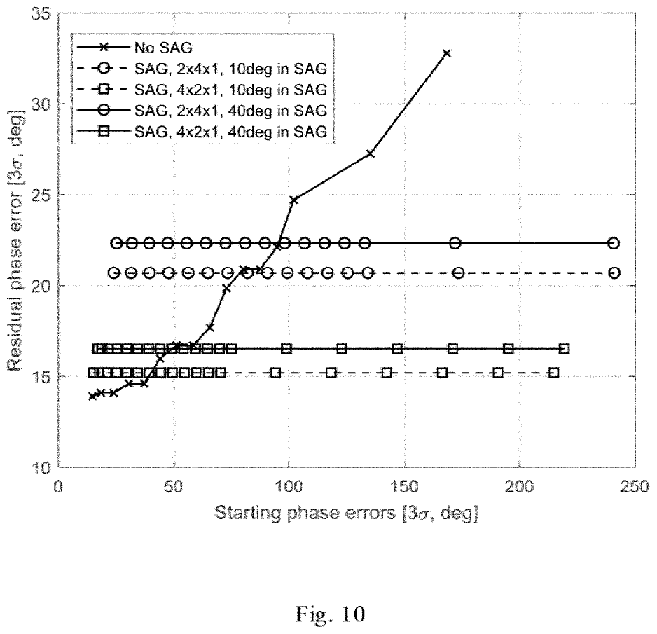

FIG. 10 shows some results of the proposed method in a LOS channel, in comparison with the classic in-field AC. To show the results of the proposed method in different phase errors, the radio unit is first calibrated into a good state, then adding the starting phase errors manually in the simulation. This can reflect the actual behavior under different scenarios. It is seen from FIG. 10 that the classic in-field AC, indicated by solid line with x “No SAG”, i.e. without splitting the antenna array to SAGs, cannot converge if the starting phase errors is too large. The residual phase errors grow quickly with the starting phase errors. Basically, it cannot meet the requirement if the starting phase is greater than 100 deg, i.e. 30 value. On the contrary, the proposed method with SAGs can always converge to a decent result no matter of what the starting phase errors is. This makes sense because the estimation on each SAG is irrelevant to the phase errors between SAGs. It is also illustrated that the impact of the phase errors between antenna subarrays in one SAG. The results are quite similar for 10 deg (30 value) and 40 deg (30 value) of this type of errors. The former one represents a well calibrated radio unit in the production line, and the latter one represents a not-so-well calibrated radio unit in the production line, or a radio unit that has had large phase drift in run-time due to environmental/aging effects. It is not necessary to have very good result in the first step calibration. A reasonable low-cost short-time first step calibration can meet the demands as well. It is noted that the result is obtained from only one UE, wherein the residual phase errors can be further reduced by aggregating results from multiple UEs.

Furthermore, the residual phase errors between SAG with 4×2×1 and SAG with 2×4×1 are compared. Interestingly, SAG with 4×2×1 has better performance than SAG with 2×4×1. This is because the angular resolution in the elevation is higher in SAG with 4×2×1. Sometimes, it is troublesome for designer to choose which one is better because the channel is actually unpredictable. However, as more and more RF chains being integrated into one TRX chipset, this won't be a problem anymore because the SAGs in the future can have good angular resolution in both azimuth and elevation directions. Besides, a flexible connection between antenna subarrays and TRX chipset is proposed to adapt to different application scenarios. As the integration continues, the proposed method will have even better performance than present one and show some more powerful capabilities.

To summarize, some advantages of embodiments herein for antenna calibration are listed in the following:

The proposed antenna calibration method is applicable in both DL AC and UL AC. In the UL AC, the CSI is estimated on the UL reference signal received by the network node 110 so the network node 110 can acquire the UL CSI directly. For the DL AC, since the CSI is estimated on the DL reference signal received by the UE 130, the estimated CSI by the UE 130 can be fed back to the network node 110. Therefore, an extra channel feedback is needed to provide DL CSI for the network node 110. This may be achieved by an iterative precoding matrix index (PMI) reporting that can feedback highly accurate CSI in an efficient way. Once the DL CSI is acquired by the network node 110, the process in the UL AC can be used in DL AC as well.

The proposed calibration for both UL AC and DL AC is an enhanced in-field AC for massive MIMO radio unit. The massive MIMO radio unit can be fully calibrated without any help from the conventional AC. After the AC, the functionalities such as beamforming, nulling beam, or other beam related processing, can work properly in the field.

The proposed antenna calibration method needs no RND board or coupler network, so the cost is saved.

The proposed antenna calibration method can avoid interruption to the traffic data.

The proposed antenna calibration method is applicable in cases where high isolation exists between TX and RX antennas.

The proposed antenna calibration method can be used for totally uncalibrated radio units.

The proposed antenna calibration method can reduce impairments of hardware in the network node and see the true performance on the operating network without impact from calibration path.

The proposed antenna calibration method can be performed periodically to track and compensate phase drifts over the time.

The proposed antenna calibration method can support SBFD operation in a massive MIMO unit.

The word “comprise” or “comprising”, when used herein, shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appended claims.

1. A method performed by a network node in a wireless communication system for antenna calibration, the network node comprises an antenna array and a number of transceiver chipsets, the antenna array comprises a number of antenna subarrays which are arranged in a number of subarray groups, SAGs, the number of SAGs are coupled to the number of transceiver chipsets, respectively, the method comprising a two-step calibration,
during a first step calibration, the method comprising:
obtaining, at a system power-up, compensation values for the number of antenna subarrays comprised in a SAG, the compensation values representing relative phase and amplitude differences between the antenna subarrays in the same SAG for two or more subcarriers; and
compensating phase and amplitude for the antenna subarrays in each SAG based on the compensation values during the system power-up; and
during a second step calibration, the method comprising:
estimating a channel-state information for the number of antenna subarrays in a SAG at a subcarrier based on a received signal from a user equipment, UE, the channel-state information being represented by a combined channel data matrix comprising channel data contributed from a communication channel between the network node and user equipment and channel data contributed from antenna calibration error between the number of antenna subarrays comprised in the antenna array;
calculating a relative antenna calibration error between the number of SAGs for each SAG based on the estimated channel state information; and
compensating one or both phase and amplitude for the antenna subarrays in each SAG based on the relative antenna calibration error between the number of SAGs for each SAG.

2. The method according to claim 1, wherein calculating a relative antenna calibration error between the number of SAGs for each SAG based on the estimated channel state information comprises:
calculating a covariance matrix on the combined channel data matrix for each SAG for a number of measurements;
calculating an average of the covariance matrices of all SAGs;
estimating angle-of-arrive or angle-of-departure based on the averaged covariance matrix to obtain a steering vector;
rotating the combined channel data matrix to a boresight position for each SAG by multiplying the combined channel data matrix with the conjugate of steering vector to get a modified channel data matrix;
calculating an average value of the modified channel data matrix for each SAG; and
calculating the relative antenna calibration error between the number of SAGs for each SAG by dividing the average value of the modified channel data matrix for each SAG with a reference value.

3. The method according to claim 1, wherein the received signal from the UE is an up-link refence signal.

4. The method according to claim 1, wherein the received signal from the UE is a signal contains channel-state information of a reference signal sent from the network node to the UE.

5. The method according to claim 1, wherein the received signal from the UE is a signal contains down-link channel data matrix.

6. The method according to claim 1, wherein the second step calibration is running periodically.

7. The method according to claim 1, wherein the compensation values for the number of antenna subarrays comprised in each SAG are estimated during production line test and stored in database of the network node.

8. The method according to claim 7, wherein an orthogonal frequency-division multiplexing, OFDM, based calibration signal with K subcarriers is used during production line test with a radio distribution network board, or over-the-air in an anechoic chamber, and wherein a channel-state information is estimated for the number of antenna subarrays comprised in each SAG at two or more subcarriers k, wherein k=1, . . . , K, to obtain the compensation values.

9. method according to claim 1, wherein obtaining at a system power-up compensation values for the number of antenna subarrays comprised in a SAG comprising obtaining the compensation values for other subcarriers than the two or more stored compensation values by interpolating the stored compensation values for the two or more subcarriers.

10. A network node in a wireless communication system, the network node comprising an antenna array and a number of transceiver chipsets, the antenna array comprising a number of antenna subarrays and the antenna subarrays are arranged in a number of subarray groups, SAGs, and the number of SAGs are coupled to the number of transceiver chipsets, respectively, the network node is configured to perform a two-step calibration, the two-step calibration comprising:
during a first step calibration:
obtaining, at a system power-up, compensation values for the number of antenna subarrays comprised in a SAG, the compensation values representing relative phase and amplitude differences between the antenna subarrays in the same SAG for two or more subcarriers; and
compensating phase and amplitude for the antenna subarrays in each SAG based on the compensation values during the system power-up; and
during a second step calibration:
estimating a channel-state information for the number of antenna subarrays in a SAG at a subcarrier based on a received signal from a user equipment, UE, the channel-state information being represented by a combined channel data matrix comprising channel data contributed from a communication channel between the network node and user equipment and channel data contributed from antenna calibration error between the number of antenna subarrays comprised in the antenna array;
calculating a relative antenna calibration error between the number of SAGs for each SAG based on the estimated channel state information; and
compensating one or both phase and amplitude for the antenna subarrays in each SAG based on the relative antenna calibration error between the number of SAGs for each SAG.

11. The network node according to claim 10, wherein the number of antenna subarrays and a shape of the antenna subarray in each SAG is arranged based on the configuration of the transceiver chipsets and required resolution in spatial domain.

12. The network node according to claim 11, wherein the antenna subarrays are coupled to power amplifiers or low noise amplifiers via antenna switches, and the network node further comprises a number of switch and power splitter chains arranged between the transceiver chipsets and the power amplifiers and low noise amplifiers, and wherein the number of switch and power splitter chains are configured such that the number of antenna subarrays and the shape of the antenna subarray in each SAG is arranged adaptively based on the configuration of the transceiver chipsets and required angular resolution at azimuth and elevation directions.

13. The network node according to claim 11, wherein the antenna subarrays are coupled to power amplifiers or low noise amplifiers via antenna switches, and a number of switch and power splitter chains are comprised inside the transceiver chipsets, and wherein the number of antenna subarrays and the shape of the antenna subarray in each SAG is arranged adaptively based on the configuration of the transceiver chipsets and required resolution in spatial domain by setting switches in the number of switch and power splitter chains comprised inside the number of transceiver chipsets.

14. A computer storage medium storing a computer program comprising program code which, when the computer program is executed by a computer, causes the computer to carry out a method for antenna calibration for a network node, the network node comprising an antenna array and a number of transceiver chipsets, the antenna array comprising a number of antenna subarrays and the antenna subarrays are arranged in a number of subarray groups, SAGs, and the number of SAGs are coupled to the number of transceiver chipsets, respectively, the network node being configured to perform a two-step calibration, the two-step calibration comprising:
during a first step calibration:
obtaining, at a system power-up, compensation values for the number of antenna subarrays comprised in a SAG, the compensation values representing relative phase and amplitude differences between the antenna subarrays in the same SAG for two or more subcarriers; and
compensating phase and amplitude for the antenna subarrays in each SAG based on the compensation values during the system power-up; and
during a second step calibration:
estimating a channel-state information for the number of antenna subarrays in a SAG at a subcarrier based on a received signal from a user equipment, UE, the channel-state information being represented by a combined channel data matrix comprising channel data contributed from a communication channel between the network node and user equipment and channel data contributed from antenna calibration error between the number of antenna subarrays comprised in the antenna array;
calculating a relative antenna calibration error between the number of SAGs for each SAG based on the estimated channel state information; and
compensating one or both phase and amplitude for the antenna subarrays in each SAG based on the relative antenna calibration error between the number of SAGs for each SAG.

15. The network node according to claim 10, wherein calculating a relative antenna calibration error between the number of SAGs for each SAG based on the estimated channel state information comprises:
calculating a covariance matrix on the combined channel data matrix for each SAG for a number of measurements;
calculating an average of the covariance matrices of all SAGs;
estimating angle-of-arrive or angle-of-departure based on the averaged covariance matrix to obtain a steering vector;
rotating the combined channel data matrix to a boresight position for each SAG by multiplying the combined channel data matrix with the conjugate of steering vector to get a modified channel data matrix;
calculating an average value of the modified channel data matrix for each SAG; and
calculating the relative antenna calibration error between the number of SAGs for each SAG by dividing the average value of the modified channel data matrix for each SAG with a reference value.

16. The network node according to claim 10, wherein the received signal from the UE is an up-link refence signal.

17. The network node according to claim 10, wherein the received signal from the UE is a signal contains channel-state information of a reference signal sent from the network node to the UE.

18. The network node according to claim 10, wherein the received signal from the UE is a signal contains down-link channel data matrix.

19. The network node according to claim 10, wherein the second step calibration is running periodically.

20. The network node according to claim 10, wherein the compensation values for the number of antenna subarrays comprised in each SAG are estimated during production line test and stored in database of the network node.
